(19) United States
(12) Patent Application Publication
(10) Pub. No.: US 2010/0290322 A1
(43) Pub. Date: Nov. 18, 2010

(54) Integrated Digital Media Player Cassette Adapter

(75) Inventors: Yasuhiro Yamamoto, Los Angeles, CA (US); Long Ho, Reseda, CA (US)

Correspondence Address: Ever Win International Corporation, 17579 Railroad Street, City of Industry, CA, 91748, US

(73) Assignee: Ever Win International Corporation, City of Industry, CA (US)

(21) Appl. No.: 12/466,188

(22) Filed: May 14, 2009

(51) Int. Cl. H04B 1/20

(52) U.S. Cl. 369/2

(57) ABSTRACT

A digital media player integrated into the housing of the cassette adapter. A cassette shaped housing of a cassette adapter includes a removable portion suitable for accommodating a digital media player in place of the portion when removed. In a most preferred embodiment, the media player is an Apple iPod Shuffle. The digital media player is affixed and integrated into the housing by means of a groove, and is connected to the record-head of the adapter by an electronic coupling means capable of transmitting an audio signal; for instance, a TSR connector or stereo jack plug. Control means for the iPod Shuffle or other media player, including but not limited to play mode, track selection, and volume, can alternatively be integrated into the housing of the adapter, or can be embodied in a separate control housing connected to the circuitry in the main housing by a conducting cable.

### BACKGROUND OF INVENTION

Cassette adapters have long been available for the purpose of allowing new media sources to be used through the relatively obsolete hardware associated with audio cassette players. Originally, such adapters arose in order to allow consumers to connect portable CD players to systems limited to audio cassette functionality; however, the technology has easily been adapted to accommodate other new forms of media as they arise, including digital media players, including Apple's popular iPod device. See for instance, U.S. Pat. No. 4,734,897 to Schotz, U.S. Pat. No. 5,444,675 to De Bie, et al., and U.S. Pat. No. 6,011,756 to Lee.

Prior art instances of audio cassette adapters typically comprise: a housing in the shape of a standard audio cassette; an internal tape-head for contacting the playback-head of a cassette player and mimicking a magnetic audio-tape transferring an audio signal; a conducting means coupled to the tape head, extending from the cassette-shaped housing, and capable of conducting an audio signal; and a connection means for attaching to the output jack of a new media source, for instance, a TRS connector or stereo/audio phone jack plug. Variations in the prior art include assorted methods for connecting the conducting means or cable from the adapter to the new media source in order to accommodate various orientations of the cassette player (i.e., side loading, front loading, or top loading).

One commonality among the variants of prior art is the externality of the new media device, coupled with the need for a conductor cable connecting the device to the cassette adapter. Some efforts have been made to provide a more integrated solution in order to avoid the “dangling cable” problem traditionally inherent in the use of cassette adapters. The dangling cable problem presents inherent aesthetic and convenience limitations. See for instance, U.S. Patent Application No. 2006/0256475 A1 by Lindsay, et al.

However, even the solutions addressing the dangling cable problem are less than optimal in that they connect to an external digital media player that is not aesthetically integrated into an existing audio system and also can be limited in their application depending upon the orientation of the audio cassette. For instance, some adapters (e.g., the adapter disclosed in U.S. Patent Application No. 2006/0256475 A1) are only useful for side loading cassette players, and have no useful application in front- or top-loading cassette players. Various attempts at solving the cable placement issue require the consumer to disassemble the housing to adjust the cable's attachment point, and then reassemble the housing. Hence, there is a need for a cassette adapter that is capable of fully integrating a specific digital media player (thereby eliminating the dangling cable problem) and has functionality without regard to the cassette player's orientation, all the while also maintaining compatible functionality with the growing variety of digital media players on the market.

### BRIEF SUMMARY OF THE INVENTION

The present inventive concept presents a solution to the dangling cable problem by optionally integrating a digital media player into the housing of the cassette adapter. The adapter is then used as though a standard cassette and is capable of playing back audio files stored in the media-player.

As one example of the inventive concept, the cassette shaped housing of a cassette adapter includes a docking portion and a removable portion of suitable size and shape to accommodate a digital media player in place of the portion when removed, thereby integrating the media-player into the functionality of the cassette adapter. In a preferred embodiment, the digital media player is a mini-media player. In a most preferred embodiment, the media player is an Apple iPod Shuffle. In a preferred embodiment, the digital media player is affixed and integrated into the housing by means of a groove, and is connected to the record-head of the adapter by an electronic coupling means capable of transmitting an audio signal; for instance, a TSR connector or stereo jack plug. Control means for the iPod Shuffle or other media player, including but not limited to play mode, track selection, and volume, can alternatively be integrated into the housing of the adapter, or can be embodied in a separate control housing connected to the circuitry in the main housing by a conducting cable.

Alternatively, the slideably removable shoulder portion of the cassette housing can be left intact and the adapter can be used as a traditional cassette adapter. As yet another alternative, a separate control housing can be mounted inline with a connector cable for alternate use with a media device not capable of being integrated into the main housing.

### BRIEF DESCRIPTION OF THE SEVERAL VIEWS OF THE DRAWING

FIG. 1 depicts a schematic circuit diagram associated with an alternative preferred embodiment of the invention.

FIG. 2 depicts lateral cutaway view of an alternative preferred embodiment of the invention.

FIG. 3 depicts lateral and perspective view of an alternative preferred embodiment of the invention.

FIG. 4 depicts lateral and perspective view of an alternative preferred embodiment of the invention.

FIG. 5 depicts lateral and perspective view of an alternative preferred embodiment of the invention.

FIG. 6 depicts lateral and perspective view of an alternative preferred embodiment of the invention.

FIG. 7 depicts lateral and perspective view of an alternative preferred embodiment of the invention.

FIG. 8 depicts lateral and perspective view of an alternative preferred embodiment of the invention.

### DETAILED DESCRIPTION OF THE INVENTION

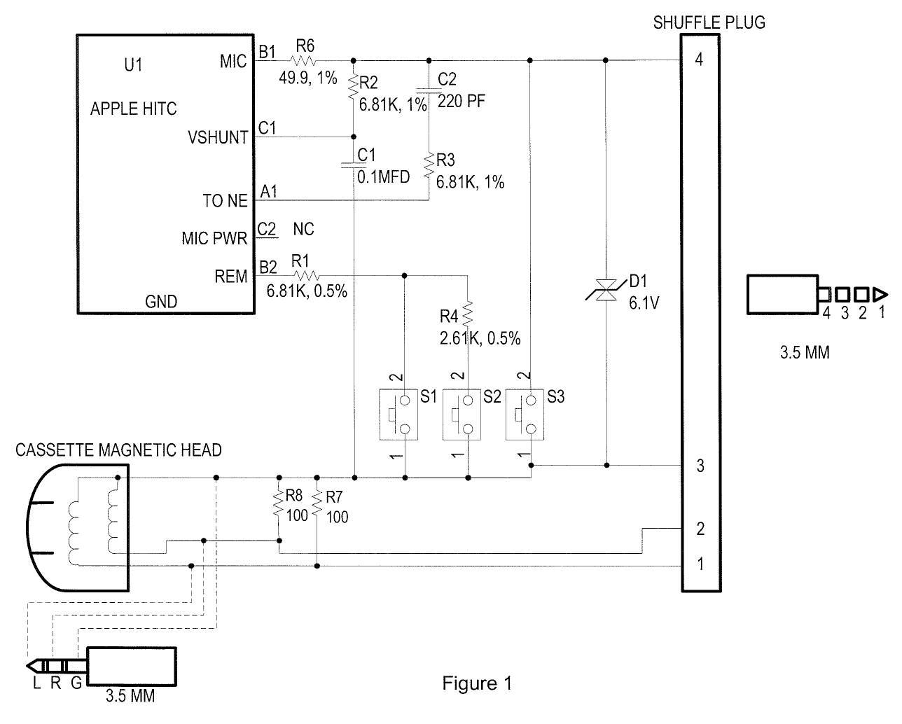

Cassette adapters are known in the art of consumer electronics, specifically home and car audio systems. FIG. 1 depicts a preferred embodiment of the circuit associated the present invention, including a means for receiving an audio signal, specifically, a phone jack plug, a conducting means for transferring an electronic audio signal and a tape or record head for converting the electronic audio signal into a magnetic signal to be read by the playback head of a cassette player. In an alternative preferred embodiment, the invention's circuitry further includes switches S1, S2 and S3, coupled to both the phone jack plug and the cassette magnetic head, for controlling an attached digital media player's playback mode, volume, and/or other parameters. An additional alternative preferred embodiment includes an auxiliary input jack plug.

In its various embodiments, the invention consists of a cassette shaped housing with internal electronics consistent with the schematic of FIG. 1 and its functional equivalents. In each of its various embodiments, the cassette shaped housing includes a removable portion of appropriate shape and size to accommodate a media-player in its place when removed. The removable portion includes connection means for coupling to the circuit of the main cassette housing and an insulated conducting cable for connecting to an alternate media device. Removing the removable portion enables a user to attach a media player in place of the removable portion; rendering an integrated media-player and cassette adapter. In various embodiments, control means for the media player are incorporated into the cassette housing or into a second, separate control housing coupled to the main cassette housing and its circuitry by an insulated conducting cable.

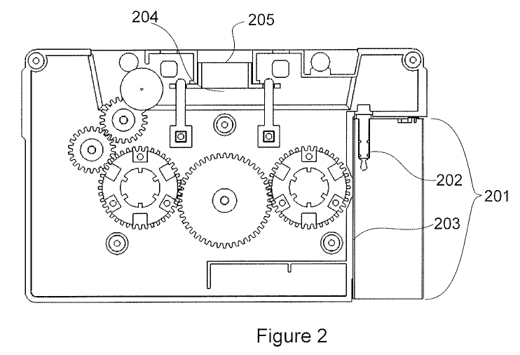

FIG. 2 shows a cutaway view of a preferred embodiment of the present invention, including media-player 201 connected at phone jack plug 202 to the docking portion of the cassette shaped housing and stabilized by shoulder groove 203. Internal wiring is not shown in FIG. 2, but various, alternative wiring schemes should be apparent to those reasonably skilled in the art by combining the information disclosed in FIGS. 1 and 2. Tape head 205 rides on a mounting mechanism, including peripheral wall 204.

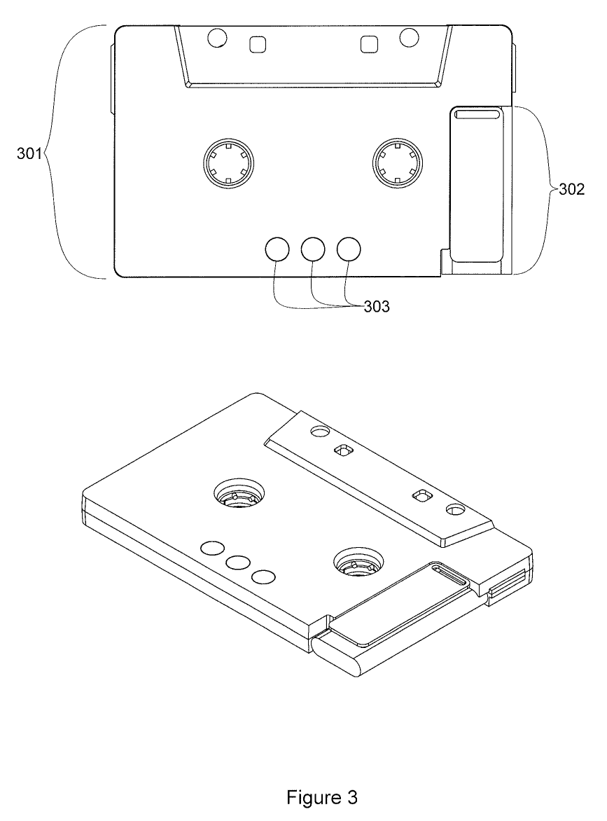

FIG. 3 shows an external view of cassette adapter 301 with integrated media-player 302 attached. In this preferred embodiment, the media player is an iPod Shuffle. Control buttons 303 are similarly integrated into the cassette adapter housing.

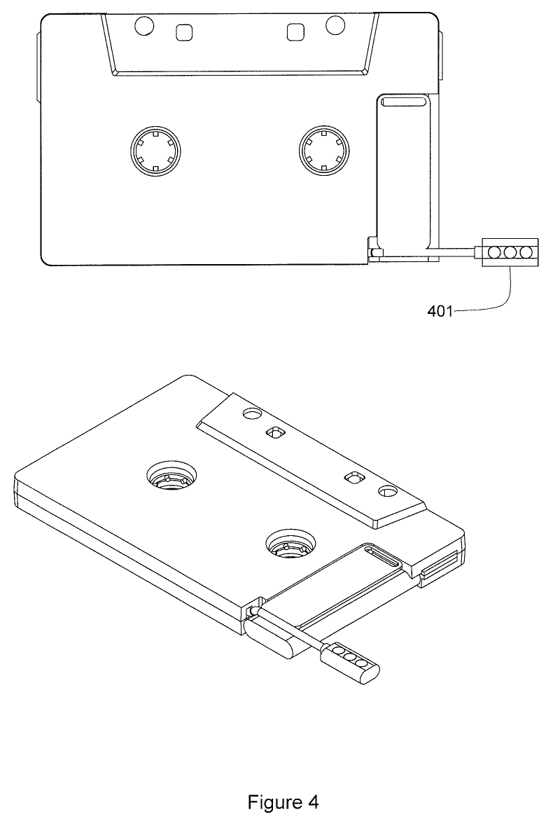

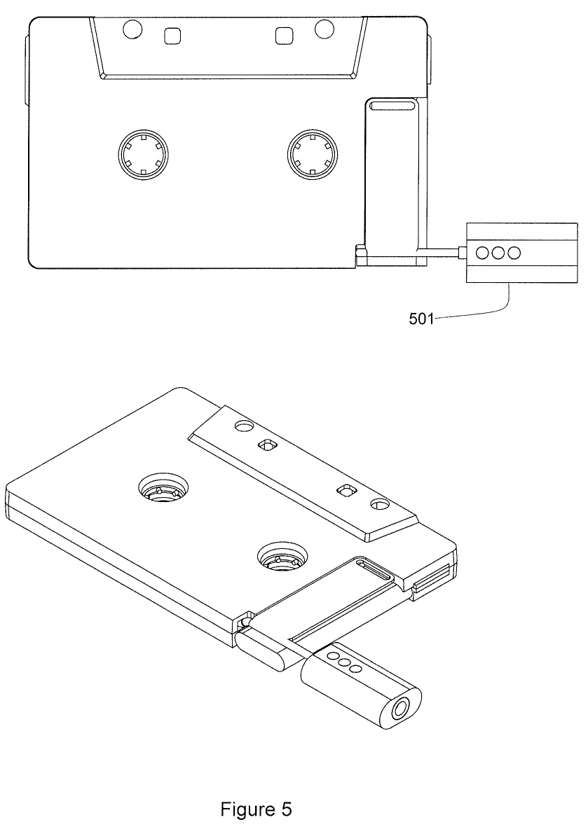

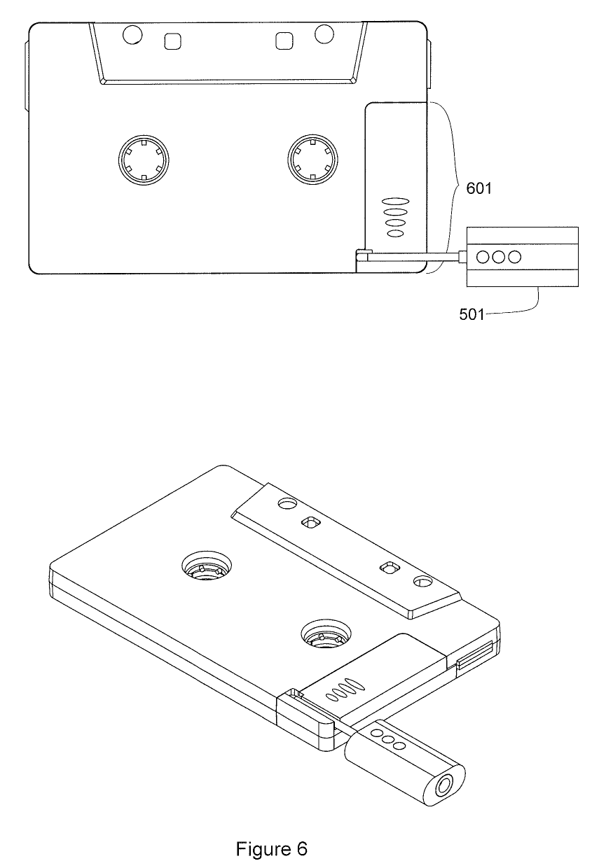

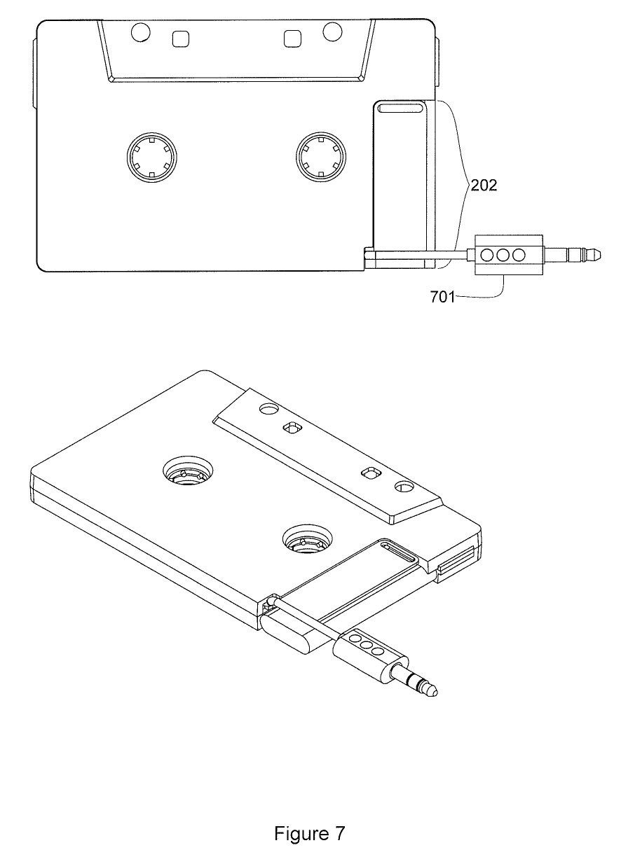

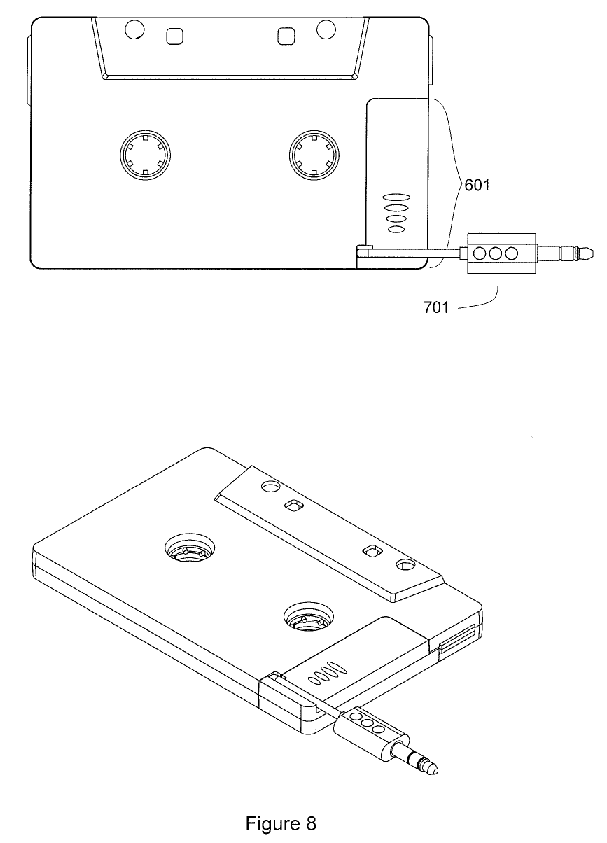

FIGS. 4 and 5 depict alternative preferred embodiments with control button-switches incorporated into a second housing 401, 501. Control housing 501 includes an auxiliary input jack. FIG. 6 depicts the docking portion of the cassette adapter housing with optionally removable portion 601 intact and separate control housing 501 (with auxiliary input phone jack) connected by a conducting insulated cable. Similarly, FIG. 7 depicts a cassette adapter embodiment with optionally removable portion removed and integrated media-player 202 connected to the adapter. Separate control housing 701 is connected by an insulated conducting cable and is shown in an alternative preferred embodiment including an auxiliary phone jack plug. FIG. 8 shows an alternative preferred embodiment with optionally removable portion 601 intact and separate control housing 701 (with auxiliary phone jack plug) connected by a conducting insulated cable.

We claim:

1. An adapter for enabling a cassette player to play audio files from a media player, comprising:
A first housing in the shape of a standard audio-cassette having an optionally removable portion and docking portion for coupling to a digital media player;
A magnetic tape-head supported by a peripheral wall within said first housing and positioned so as to contact a playback-head of a cassette player audio system;
An electromagnetic coupler proximally located to said removable portion of said first housing, connected to said magnetic tape-head, for receiving electromagnetic audio signals from a digital media player and transmitting said signals to said magnetic tape-head.

2. The adapter of claim 1 wherein the coupler is a phone jack plug.

3. The adapter of claim 1 wherein the docking portion of said housing further comprises a groove along said housing for stabilizing the connected media player and a phone jack plug for mechanically and electronically coupling the media-player to said housing and said magnetic tape-head.

4. The adapter of claim 1 wherein the optionally removable portion comprises an approximately rectangular corner-piece of said first housing.

5. The adapter of claim 1 wherein the optionally removable portion of said housing is the size and shape of a digital media player.

6. The adapter of claim 1 wherein the optionally removable portion of said housing is approximately the size and shape of the Apple iPod Shuffle, third generation or later.

7. The adapter of claim 1 further comprising one or more controls for the functions on the connected media player selected from the group comprising: power off/on, playback mode, track selection, track skip, repeat, shuffle, volume and mute.

8. The adapter of claim 8 wherein each said such control comprises a button switch.

9. The adapter of claim 8 wherein said controls are integrated into said first housing.

10. The adapter of claim 8 wherein said controls are contained in a second housing for controlling said functions of the media player during playback of audio files.

11. The adapter of claim 11 wherein said second housing further includes a phone jack for coupling to a second, alternate media device.

12. The adapter of claim 1 1 wherein said second housing further includes a phone jack plug for coupling to a second, alternate media device.

13. The adapter of claim 1 further comprising a conducting cable coupled to said tape-head, extending from said first housing, and terminating with a phone jack plug for optionally connecting to a media player.

15. The combination of the cassette adapter of claim 1 and a digital media player.

16. The combination of claim 14 wherein said digital media player is an Apple iPod Shuffle, third generation or later.
